(19) United States
(12) Patent Application Publication
(10) Pub. No.: US 2015/0056530 A1
(43) Pub. Date: Feb. 26, 2015

(54) HEAT-SOURCE COOLING DEVICE

(71) Applicants: Shunjiro KIKAWA, Kariya-city, Aichi-pref (JP); Keigo SUEMATSU, Toyota-shi, Aichi-ken (JP); DENSO CORPORATION, Kariya-city, Aichi-pref. (JP)

(72) Inventors: Michio Nishikawa, Nagoya-city (JP); Takurou Furukoshi, Kariya-city (JP); Shunjiro Kikawa, Kariya-city (JP); Keigo Suematsu, Toyota-shi (JP)

(73) Assignee: TOYOTA JIDOSHA KABUSHIKI KAISHA, Toyota-shi, Aichi-ken (JP)

(21) Appl. No.: 14/390,627

(22) PCT Filed: Apr. 4, 2013
(86) PCT No.: PCT/JP2013/002332

§ 371 Date: Oct. 3, 2014

(30) Foreign Application Priority Data
Apr. 5, 2012 (JP) 2012-086549

(51) Int. Cl. B60L 11/18; B60W 10/28; F01P 7/16; H01M 8/04; B60K 11/04

(52) U.S. Cl. CPC B60L 11/1892; H01M 8/04029; B60K 11/04; F01P 7/16; B60W 10/28
USPC 429/437; 165/104.31; 429/442; 236/34.5

(57) ABSTRACT

A fuel cell is used for generating driving energy for a vehicle. The reserve-tank inlet valve is located between a suction side of the coolant pump and a position in the coolant circuit at which a pressure of the coolant controlled by the reserve-tank inlet valve is an intermediate value between a discharge pressure of the coolant pump and a suction pressure of the coolant pump during an operation of the coolant pump. Even if the fuel cell is stopped generating electric power, the coolant pump is made continue operating even when the vehicle is traveling in a case that a coolant temperature exceeds a predetermined temperature. The coolant pump is made stop rotating after the coolant temperature becomes lower than or equal to the predetermined temperature. Accordingly, an occurrence of cavitation in the coolant pump is restricted at the time of restarting the fuel cell just after the fuel cell is stopped in a vehicle that is driven by the driving energy generated by the fuel cell working as a driving-energy generator.

### CROSS REFERENCE TO RELATED APPLICATION

This application is based on Japanese Patent Application No. 2012-086549 filed on Apr. 5, 2012, the contents of which are incorporated herein by reference in its entirety.

### FIELD OF THE INVENTION

The present disclosure relates to a heat-source cooling device in which heat caused by a heat source that provides energy for traveling of a vehicle is radiated at a radiator through coolant. The heat-source cooling device has an electric coolant pump for circulating coolant. Especially, the present disclosure is related to a heat-source cooling device for a vehicle such as a fuel-cell vehicle and a hybrid vehicle, in which a driving-energy generator provided with a fuel cell or an engine of the hybrid vehicle may be stopped during a traveling of the vehicle.

### BACKGROUND OF THE INVENTION

Conventionally, as described in Patent Document 1, there is a well-known technique that engine cooling water continuously circulates in a turbo (i.e., a super charger) after a vehicle is stopped such that a bearing of the turbo is restricted from being seized, in a dead soak that is a state in which a vehicle is stopped suddenly, and the engine as a driving-energy generator is stopped after rotating at high speed.

### PRIOR ART DOCUMENT

Patent Document 1: Japanese Unexamined Utility Model Application Publication No. S61-132477

### SUMMARY OF THE INVENTION

A well-known coolant pump such as a mechanical coolant pump or an electric coolant pump stops circulating coolant when the vehicle is stopped and when the engine stops. That is, when the engine stops, the coolant pump is stopped no matter if a coolant temperature exceeds a predetermined temperature or not. When the vehicle is moving, the coolant pump is not stopped since the engine is in an operation state.

On the other hand, in recent years, a heat source that provides energy for traveling of a vehicle is required to be capable of saving fuel more greatly than a conventional heat source. For example, various modifications for vehicles such as a fuel-cell vehicle and a vehicle of which engine stops automatically or starts to save energy even in an operation state have been made. However, if a cooling performance for cooling the heat source is unstable, a fuel-saving operation of the heat source may have harmful effects.

Especially, in a case of the fuel-cell vehicle, a coolant temperature raises and reaches to 95° C. while the fuel-cell vehicle travels up a hill. When a fuel supply to a fuel cell, an electric fan (i.e., a radiator fan) of a radiator, and a coolant pump are put in an arrest state promptly after the coolant temperature raises, there is a fear that an efficiency of power generation that is performed by a fuel-cell stack at the time of restarting of the fuel-cell vehicle decreases.

Further, a driving-energy generator that is provided with a fuel cell or a driving-energy generator that is provided with an engine of a hybrid vehicle may be stopped even while the vehicle is traveling. In this case, there is a fear that the efficiency of the power generation that is performed by the fuel-cell stack and an operating efficiency of the engine are decreased at the time of restarting of the fuel cell and the engine. The reason of the fear is found in a cavitation as described after.

It is an objective of the present disclosure to provide a heat-source cooling device with which an occurrence of cavitation in a coolant pump is restricted, when a driving-energy generator that is disposed in a vehicle moved by energy generated by the driving-energy generator is restarted after the driving-energy generator is stopped or after a power down.

According to an embodiment of the present disclosure, a heat-source cooling device has: an electric coolant pump; a heat source that is cooled by coolant discharged by the coolant pump and is used as a driving-energy generator generating energy for traveling of a vehicle; a radiator in which coolant that is heated at the heat source radiates heat; a coolant circuit through which the coolant pump, the heat source, and the radiator are connected annularly; a reserve tank taking the coolant thereinto from the coolant circuit or releasing the coolant to the coolant circuit; and a reserve-tank inlet valve controlling an inflow of the coolant into the reserve tank and an outflow of the coolant from the reserve tank. The reserve-tank inlet valve is located between a suction side of the coolant pump and a position in the coolant circuit at which a pressure of the coolant is an intermediate value between a discharge pressure of the coolant pump and a suction pressure of the coolant pump during an operation of the coolant pump. The heat-source cooling device further comprises a coolant-pump-operation continuation part making the coolant pump continue operating until a temperature of the coolant reduces to be lower than or equal to a predetermined temperature, when the heat source is stopped or is determined to be stopped, and when the coolant temperature exceeds the predetermined temperature.

Accordingly, heat that is generated at the heat source by rotating the coolant pump can be cooled in the radiator. Coolant in the coolant circuit flows into and from between the coolant circuit and the reserve tank through the reserve-tank inlet valve depending on a pressure of coolant in the coolant circuit. Further, although a pressure difference between a pressure at a discharge side of the coolant pump and a pressure at a suction side of the coolant pump increases while the rotation speed of the coolant pump increases, a pressure of coolant controlled by the reserve-tank inlet valve is kept to be lower than the intermediate pressure between the pressure at the discharge side of the coolant pump and the pressure at the suction side of the coolant pump. In a case that the heat source is stopped or is determined to be stopped and that the heat generated by the heat source is reduced, the coolant pump can be made continue operating such that the coolant is cooled until the coolant temperature becomes lower than or equal to the predetermined temperature, when the coolant temperature exceeds the predetermined temperature.

Accordingly, the coolant temperature decreases while the coolant pump is made continue operating, and the coolant can be restricted from flowing from the coolant circuit into the reserve tank. Therefore, a pressure at a suction port of the coolant pump can be restricted from decreasing at the time of restarting a performance of the driving-energy generator and a performance of the coolant pump, and an occurrence of cavitation in the coolant pump can be restricted. By restricting the occurrence of the cavitation, the heat source can be cooled stably, and the driving-energy generator can perform with a high efficiency.

### BRIEF DESCRIPTION OF THE DRAWINGS

FIG. 1 is a diagram showing a heat-source cooling device according to a first embodiment of the present disclosure.

FIG. 2 is a graph showing a pressure characteristic of a coolant pump shown in FIG. 1 and a variation of an internal pressure at a reserve-tank inlet valve shown in FIG. 1.

FIG. 3 is a schematic cross-sectional view of the reserve-tank inlet valve according to the first embodiment.

FIG. 4 is a graph showing an operation characteristic of the reserve-tank inlet valve according to the first embodiment.

FIG. 5 is a diagram showing a heat-source cooling device according to a comparison example.

FIG. 6 is a flow chart showing a control of the heat-source cooling device according to the first embodiment.

FIG. 7 is a diagram for comparing an operation of the heat-source cooling device according to the first embodiment to an operation of the heat-source cooling device according to the comparison example.

FIG. 8 is a performance mapping showing a performance of the heat-source cooling device according to the comparison example, shown in FIG. 7.

FIG. 9 is a performance mapping showing a performance of the heat-source cooling device according to the first embodiment.

FIG. 10 is a flow chart showing a control of a heat-source cooling device according to a second embodiment.

FIG. 11 is a flow chart showing a control of a heat-source cooling device according to a third embodiment.

### DETAILED DESCRIPTION OF THE PREFERRED EMBODIMENTS

Embodiments of the present disclosure will be described hereafter referring to drawings. In the embodiments, a part that corresponds to a matter described in a preceding embodiment may be assigned with the same reference number, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

First, inventors of the present disclosure conducted various experiments and found that a cavitation is caused in a coolant pump at the time of restarting a fuel-cell vehicle or the like, and that a power generating efficiency or the like of a fuel-cell stack decreases since a coolant supply to a fuel cell becomes unstable due to the cavitation.

A cause of such a fear will be described hereafter. An electric coolant pump supplies coolant to a radiator (i.e., a radiator) such that the coolant is cooled. However, when the cavitation is caused in the coolant pump, a discharge amount of the coolant pump becomes turbulent, and it becomes impossible for a heat source to operate with high efficiency. The cavitation is caused by rotating an impeller of the coolant pump at high speed while a pressure at a suction side of the coolant pump decreases. It is preferable to set a pressure of coolant high so as to restrict the occurrence of the cavitation.

The radiator performs to restrict the heat source from being over heated. Coolant circulates in the radiator and cools the heat source so as to restrict a temperature of the heat source from exceeding a predetermined temperature. Generally, coolant has a characteristic that the coolant is not frozen at 0° C. as the coolant is referred to as an antifreeze fluid. However, a boiling point of the refrigerant is 100° C. and is not different from a boiling point of water.

Since the heat source becomes very high in temperature, coolant is boiled and evaporated away when the coolant is used under normal environment. Thus, a coolant circuit including the radiator is sealed gas-tightly. By sealing a space for the coolant gas-tightly, a pressure of the coolant raises when the coolant is expanded due to heat from the heat source, since the space is limited. In the result, the boiling point raises. That is, the coolant is not boiled when the coolant becomes 100° C.

One of components performing a pressure adjustment in the radiator is a reserve-tank inlet valve. Generally, the reserve-tank inlet valve is known as a radiator cap. The reserve-tank inlet valve controls an inflow and an outflow of the coolant relative to a reserve tank.

The reserve-tank inlet valve pressurizes the coolant such that the coolant is not boiled at 100° C. The reserve-tank inlet valve has a spring at a back side of the reserve-tank inlet valve, and the spring pressurizes the coolant by strongly pressing a valve part of the reserve-tank inlet valve.

As is well-known in the art, when the coolant temperature raises, and when the coolant is expanded, the reserve-tank inlet valve having a pressure valve and a vacuum valve is pressed by the spring while a coolant pressure of the coolant is lower than a predetermined pressure. When the coolant pressure exceeds the predetermined pressure, a pressing pressure applied to the spring from the coolant exceeds a pressing pressure applied to the valve part from the spring. Accordingly, the coolant flows into the reserve tank with a volume that corresponds to a volume of the coolant pushing up the spring and expanding.

When the coolant is cooled to some extent, the coolant flows toward the radiator just for a decreased volume corresponding to a volume of coolant flowing out of the reserve tank due to a negative pressure caused in the radiator. This performance is repeated constantly such that an internal pressure in the radiator is fixed, and such that the radiator is constantly kept to be filled with the coolant.

The heat source becomes higher in temperature during a traveling of the vehicle than a temperature just after a fuel supply to the heat source is stopped. Accordingly, it is recommended to drive for cooling down after using the heat source hardly. However, such cooling down is not realistic in some state.

When the valve part of the reserve-tank inlet valve is selected to raise the coolant pressure so as to have a higher boiling point, the coolant becomes less boiled. Further, the cavitation is occurred less likely. Moreover, since a temperature difference between the coolant temperature and an outside temperature increases while the coolant temperature raises, a radiation efficiency is improved.

However, when the coolant pressure becomes too high, a load is put on a tube or the like configuring a cooling system. Therefore, it is not preferable to set the coolant pressure at the reserve-tank inlet valve higher than necessary.

Thus, the reserve-tank inlet valve is located to be closer to the suction side of the coolant pump than a position in the coolant circuit at which the coolant pressure controlled by the reserve-tank inlet valve is an intermediate value between a discharge pressure of the coolant pump and a suction pressure of the coolant pump during an operation of the coolant pump. Generally, the reserve-tank inlet valve is disposed as a radiator cap at an inlet of the radiator that is located at the suction side of the coolant pump.

The coolant pressure controlled by the reserve-tank inlet valve is kept to be lower than the intermediate pressure to some extent, by locating the reserve-tank inlet valve to be closer to the suction side of the coolant pump than the position in the coolant circuit at which the coolant pressure controlled by the reserve-tank inlet valve becomes the intermediate value between the discharge pressure of the coolant pump and the suction pressure of the coolant pump during the operation of the coolant pump.

If the reserve-tank inlet valve is located to be closer to a discharge side of the coolant pump such as a discharge port of the coolant pump than the position in the coolant circuit at which the coolant pressure becomes the intermediate value, high-pressure coolant just after being pressurized by the coolant pump is discharged from the coolant pump. Accordingly, the coolant cannot be kept at a required high pressure.

Further, if the reserve-tank inlet valve is located around a suction port of the coolant pump, coolant that is pressurized by the coolant pump and depressurized in the coolant circuit is not emitted into the reserve tank. Accordingly, since an internal pressure in the coolant circuit becomes too high, an abnormality, for example, a damage of the tube, due to a capacity to resist pressure is caused.

In other words, the occurrence of the cavitation can be restricted by locating the reserve-tank inlet valve such that a coolant pressure around the suction port of the coolant pump is set as a standard pressure, for dealing with causing of the cavitation. However, in such a way, a high-coolant-temperature state is caused when the coolant pump pressurizes the coolant to a large degree, and the discharge pressure of the coolant pump becomes extremely high when a pressure in the cooling system increases. Accordingly, a pressure resistance of the tube in which the coolant flows, products for the cooling system, and an object to be cooled are required to be improved. Thus, a cost is increased substantially.

Therefore, if the position and a structure of the reserve-tank inlet valve are changed such that the coolant becomes high pressure, an extra load is put on the tube, a sealing, and the like.

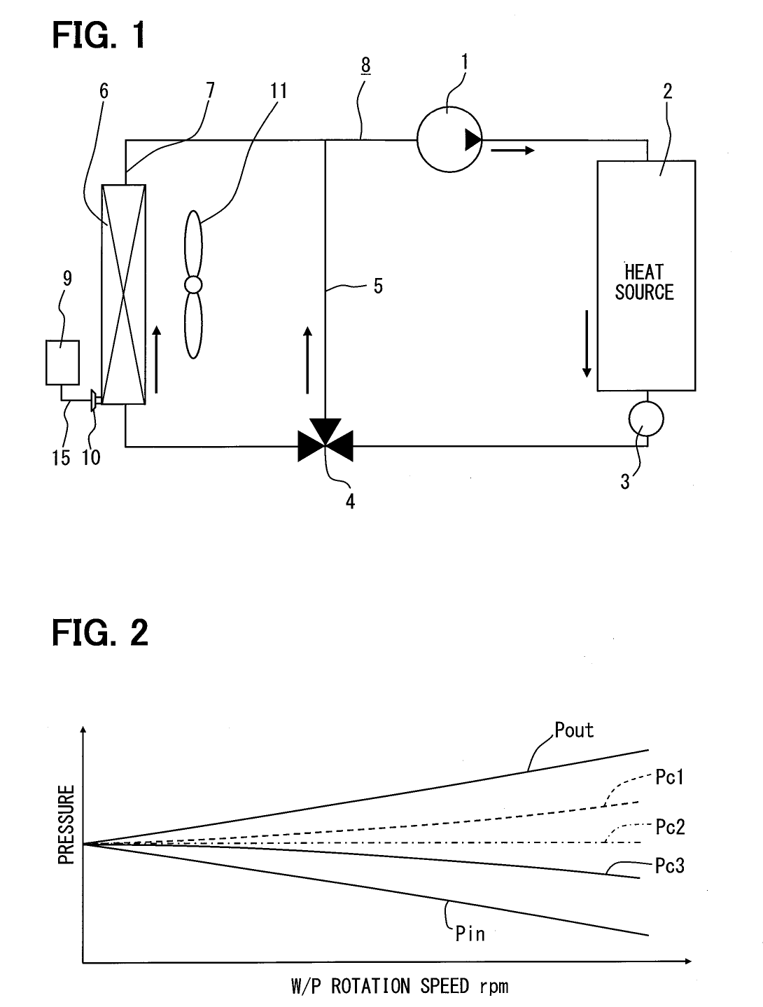

Hereinafter, a heat-source cooling device that restricts an occurrence of a cavitation at the time of restarting of a driving-energy generator just after the driving-energy generator is stopped will be described referring to FIGS. 1 to 9, according to a first embodiment of the present disclosure.

In FIG. 1, a coolant pump (i.e., a water pump or a W/P) 1 is an electric pump and has an impeller that is operated by an electric motor. The electric coolant pump 1 is controlled by an unshown electrical control unit (i.e., an ECU) such that a rotation speed of the coolant pump 1 increases to secure a radiation efficiency when a coolant temperature of coolant increases.

A fuel cell (i.e., a FC stack) that is used as an example of a heat source 2 or a driving-energy generator and a fuel-cell sensor 3 are disposed at a discharge side of the coolant pump 1. The heat source 2 is cooled by coolant circulating in the heat source 2. The heat source 2 generates energy for traveling of a vehicle.

A temperature sensor in the fuel-cell sensor 3 detects a coolant temperature of coolant flowing through the heat source 2. A rotary valve configuring a switching valve 4 switches between a bypass passage 5 and a radiation passage 7 that passes through a radiator (i.e., a radiator) 6. Coolant also can flow both in the bypass passage 5 and the radiation passage 7 with a predetermined flow rate depending on an opening degree of the switching valve 4. Since the switching valve 4 can make the coolant to flow only in the bypass passage 5 that bypasses the radiator 6 or only in the radiator 6, the switching valve 4 contributes to stabilize the coolant temperature.

The radiator 6 makes coolant that is heated at the heat source 2 to radiate heat. A coolant circuit 8 is provided with a pipe annularly connected at least to the coolant pump 1, the heat source 2, and the radiator 6. A reserve tank 9 is used such that coolant flows into or flows out between the reserve tank 9 and the coolant circuit 8. The radiator 6 has a radiator cap providing a reserve-tank inlet valve 10 controlling an inflow into and an outflow from the reserve tank 9.

The reserve-tank inlet valve 10 is located at a position that is closer to a suction side of the coolant pump 1 to some extent than a position in the coolant circuit 8, at which a pressure of coolant controlled by the reserve-tank inlet valve 10 becomes an intermediate value between a discharge pressure of the coolant pump and a pressure at a suction part of the coolant pump during the operation of the coolant pump. This matter will be described referring to FIG. 2.

FIG. 2 shows a pressure characteristic of the coolant pump 1 shown in FIG. 1 and an internal pressure of the reserve-tank inlet valve 10, especially, a variation of an internal pressure Pc in a cap of the radiator cap. As shown in FIG. 2, a pressure difference between a suction-side pressure Pin at the suction part of the coolant pump 1 and a pressure Pout at a discharge part of the coolant pump increases as the rotation speed (i.e., a W/P rotation speed) of the coolant pump 1 (i.e., a W/P pump 1) increases. A characteristics Pc1, Pc2, Pc3 of the internal pressure Pc in the well-known reserve-tank inlet valve 10 is set such that the internal pressure Pc hangs down as the characteristics Pc3 while the rotation speed of the coolant pump 1 increases.

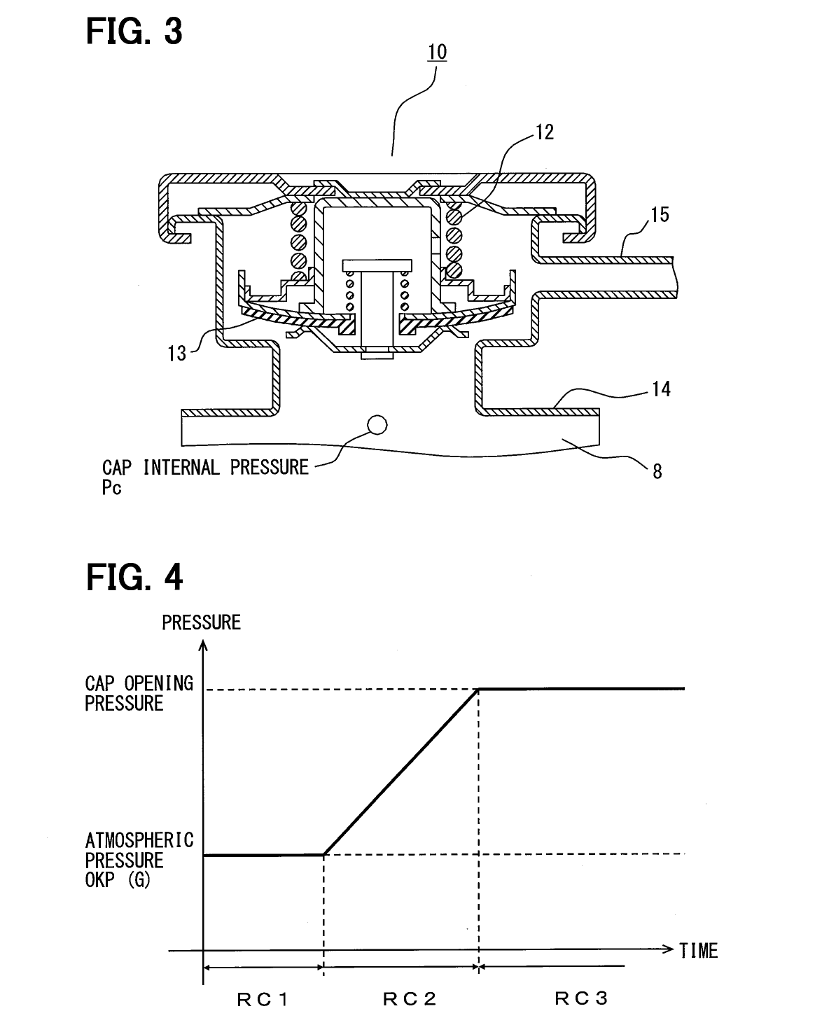

FIG. 3 shows a radiator cap 10 providing the reserve-tank inlet valve 10. FIG. 4 shows an operation characteristic of the reserve-tank inlet valve 10. The reserve-tank inlet valve 10 has a valve spring 12 and a pressure valve 13 and is attached to a radiator upper tank 14 as shown in FIG. 3.

A pipe 15 is disposed so as to communicate with the reserve tank 9 shown in FIG. 1. The cap internal pressure (i.e., the internal pressure) Pc is a pressure at a part in the coolant circuit 8 that is nearest to the reserve-tank inlet valve 10 in an area of the coolant circuit 8 in which the pressure is controlled by the reserve-tank inlet valve 10, as shown in FIG. 3.

Coolant flows from the reserve tank 9 into the coolant circuit 8 through the pipe 15 when the internal pressure Pc is an atmospheric pressure, in other words, 0 KP (G) in FIG. 4, due to an operation of the valve spring 12 in the reserve-tank inlet valve 10. This state is shown by an area RC1 in FIG. 4.

When the internal pressure Pc increases and reaches to an area RC2 shown in FIG. 4, a flow of coolant between the reserve tank 9 and the coolant circuit 8 through the pipe 15 is cut off. When the internal pressure Pc further increases to a cap opening pressure and is in an area RC3 shown in FIG. 4, coolant flows through the pipe 15 from the coolant circuit 8 to the reserve tank 9.

As described above, the coolant repeatedly flows into and from between the reserve tank 9 and the coolant circuit 8. Since the coolant circuit 8 is a sealed space, an internal pressure in the coolant circuit 8 increases when coolant flows from the reserve tank 9 into the coolant circuit 8. On the other hand, the internal pressure in the coolant circuit 8 decreases when coolant flows into the reserve tank 9.

When the internal pressure in the coolant circuit 8 increases, a part of coolant at which a coolant pressure is lower than a saturated vapor pressure, due to a rotation of the impeller of the coolant pump 1. Accordingly, the cavitation is hardly occurred. Then, the reserve-tank inlet valve 10 may be selected to have a characteristic that facilitates coolant to flow from the reserve tank 9 to the coolant circuit 8 such that the occurrence of the cavitation is restricted. In such a case, the cap opening pressure shown in FIG. 4 may be increased such that the reserve-tank inlet valve 10 has a characteristic that coolant hardly flow from the coolant circuit 8 to the reserve tank 9.

In the result, although the coolant circuit 8 is pressurized, the rotation speed of the coolant pump 1 increases, the coolant temperature increases, and the internal pressure in the coolant circuit 8 becomes extremely high since coolant flows hardly from the coolant circuit 8 to the reserve tank 9. In the result, as described above, the internal pressure in the coolant circuit 8 becomes too high, and the abnormality, for example, the damage of the tube, due to a capacity to resist pressure is caused. Therefore, if the reserve-tank inlet valve 10 is switched to have the internal pressure that is high more than necessary, an extra load is only put on the tube, a sealing, and the like.

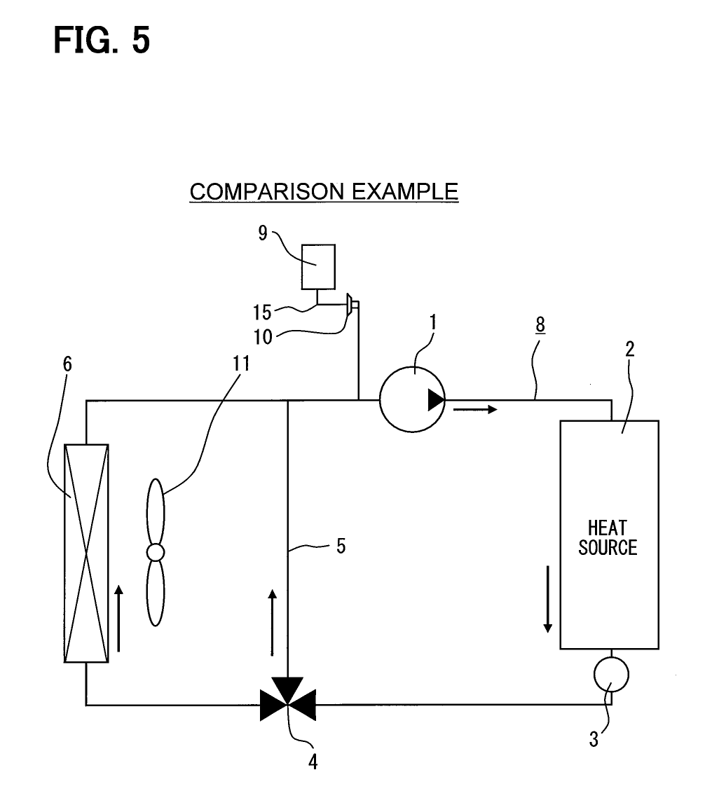

Moreover, if the reserve-tank inlet valve 10 having the same characteristic is used, a pressure variation in the coolant circuit 8 is changed depending on an attachment location at which the reserve-tank inlet valve 10 is attached. Generally, the reserve-tank inlet valve 10 as the radiator cap is disposed at an intake side of the radiator 6 that is located downstream of the switching valve 4, as shown in FIG. 1. However, as an extreme example shown in FIG. 5 as a comparison example, the reserve-tank inlet valve 10 may be disposed near the suction part of the coolant pump 1.

In FIG. 5, a pressure at the suction part of the coolant pump 1 is a value after a pressure at the discharge port decreases due to a pressure loss. Thus, when the reserve-tank inlet valve 10 is disposed near the suction part of the cooling pump 1, the internal pressure Pc becomes low. In the result, the number of times that the area RC3 shown in FIG. 4 is caused and coolant flows from the coolant circuit 8 to the reserve tank 9 decreases, and the internal pressure of the coolant circuit 8 becomes high.

In this case, the internal pressure in the coolant circuit 8 is pressurized as the same as a case that the reserve-tank inlet valve 10 having the characteristic that coolant flows hardly from the coolant circuit 8 to the reserve tank 9 is used. However, since coolant flows hardly from the coolant circuit 8 to the reserve tank 9, the rotation speed of the coolant pump 1 increases, the coolant temperature increases, and the internal pressure of the coolant circuit 8 becomes extremely high. In the result, the abnormality, for example, the damage of the tube, due to a capacity to resist pressure is caused.

The characteristic Pc1 of the internal pressure Pc shown by a dashed line in FIG. 2 shows a characteristic that the internal pressure Pc jumps when the rotation speed of the coolant pump 1 increases. The reserve-tank inlet valve 10 having the characteristic Pc1 is avoided being used since the internal pressure in the coolant circuit 8 becomes too high, and the abnormality, for example, the damage of the tube, due to a capacity to resist pressure is caused.

The characteristic Pc2 of the internal pressure Pc shown by a one-dot line in FIG. 2 shows a characteristic that the internal pressure Pc is fixed, for example, to the intermediate value Pc2 between the discharge pressure of the coolant pump 1 and the pressure at the suction part of the coolant pump 1 at the time of the operation of the coolant pump 1, even if the rotation speed of the coolant pump 1 increases.

It is appropriate for embodiments of the present disclosure to use the reserve-tank inlet valve 10 having a predetermined characteristic and to dispose the reserve-tank inlet valve 10 at the position closer to the suction side of the coolant pump 1 to some extent than the position in the coolant circuit 8 at which the internal pressure Pc becomes the intermediate value Pc2. The intermediate value Pc2 is intermediate between the discharge pressure of the coolant pump 1 and the pressure at the suction part of the coolant pump 1 at the time of the operation of the coolant pump 1 such that the internal pressure Pc hangs down as the characteristic Pc3.

That is, the internal pressure Pc decreases due to an increase of the rotation speed of the coolant pump 1 as the characteristic Pc3 of the internal pressure Pc with respect to a variation of the rotating speed of the coolant pump 1. By selecting such the reserve-tank inlet valve 10, the abnormality, for example, the damage of the tube, due to a capacity to resist pressure is not caused due to a too much increase of the internal pressure in the coolant circuit 8 even if the rotation speed of the coolant pump 1 increases, an ambient temperature changes, and generated heat generated by the heat source 2 is changed.

However, an abnormality of an occurrence of the cavitation is not restricted. Therefore, the heat-source cooling device of the present disclosure has a coolant-pump-operation continuation part that makes the coolant pump 1 continue rotating such that the coolant is cooled until the coolant temperature becomes lower than or equal to a predetermined temperature regardless if the vehicle is traveling or stopped traveling, when a heat amount supplied from the heat source 2 to coolant is smaller than a predetermined heat amount and when a required discharge amount of the coolant pump 1 is zero, in a case that the coolant temperature exceeds a predetermined temperature. The coolant-pump-operation continuation part will be described below.

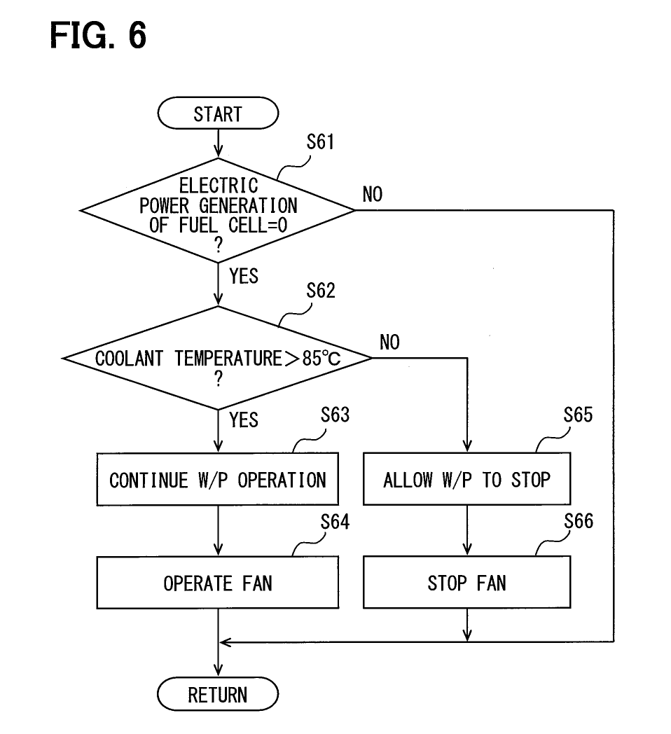

As shown in FIG. 6, when a control of the present disclosure is started, an electric power generation generated by a fuel cell as the heat source 2 is determined if the electric power generation is smaller than a predetermined amount, at step S61. Although the electric power generation may be an eventual amount of a power generation or may be a required amount of the electric power generation, the electric power generation is shown as the eventual amount of the electric power generation in the first embodiment. That is, the electric power generation detected by the current sensor and/or a voltage sensor in the fuel-cell sensor 3 is determined if the electric power generation is practically zero or not.

That is, the electrical power generation is determined to be practically zero when an output current from the fuel cell or an output voltage from the fuel cell detected by the fuel-cell sensor 3 is zero or determined to be zero.

When the electrical power generation is determined not to be practically zero, the control ends. When the electrical power generation is determined to be practically zero, it is determined at step S62 if the coolant temperature detected by a temperature sensor in the fuel-cell sensor 3 is higher than 85° C. or not.

When the coolant temperature detected by the temperature sensor is higher than 85° C., the electric coolant pump 1 is made continue operating at step S63. A control operation at step S63 may be an example of the coolant-pump-operation continuation part. Subsequently, a process proceeds to step S64, and an electric fan 11 that blows air to the radiator 6 is rotated.

While the coolant pump 1 is made continue rotating until the coolant temperature becomes lower than or equal to the predetermined temperature, the coolant pump 1 discharges coolant with a discharge capacity that is higher than or equal to 50% of a maximum discharge capacity of the coolant pump 1. Accordingly, time needed to cool the coolant until the coolant temperature becomes lower than or equal to the predetermined temperature can be shortened.

Further, while the coolant pump 1 is continued rotating such that the coolant is cooled until the coolant temperature becomes lower than or equal to the predetermined temperature, the switching valve 4 shown in FIG. 1 supplies at least a part of the coolant toward the radiator 6. Accordingly, the coolant is cooled promptly by using the radiator 6.

While the coolant pump 1 is continued rotating such that the coolant is cooled until the coolant temperature becomes lower than or equal to the predetermined temperature, the time needed to cool the coolant until the coolant temperature becomes lower than or equal to the predetermined temperature can be shortened since the electric fan 11 is operated and the radiator 6 is cooled by a cooling air.

Moreover, when the coolant temperature decreases to be lower than or equal to 85° C. while the electric power generation of the fuel cell (2) is zero, the process proceeds to step S65, and the electric coolant pump 1 is allowed to be stopped. Accordingly, the coolant pump 1 is made operate as long as the coolant pump 1 is not required to operate for other controls (including a control described after), for example, a control of a vehicle air conditioner that conditions air in a passenger compartment. Subsequently, the electric fan 11 is stopped rotating at step S66.

A control mode such as a temperature increase control so as to restrict a temperature of the FC stack in the fuel cell (2) from increasing or an ion collecting control so as to reduce an ion concentration in coolant is included in the other controls. When such control modes are performed, a coolant amount that is larger than a required amount for the electric power generation may be required.

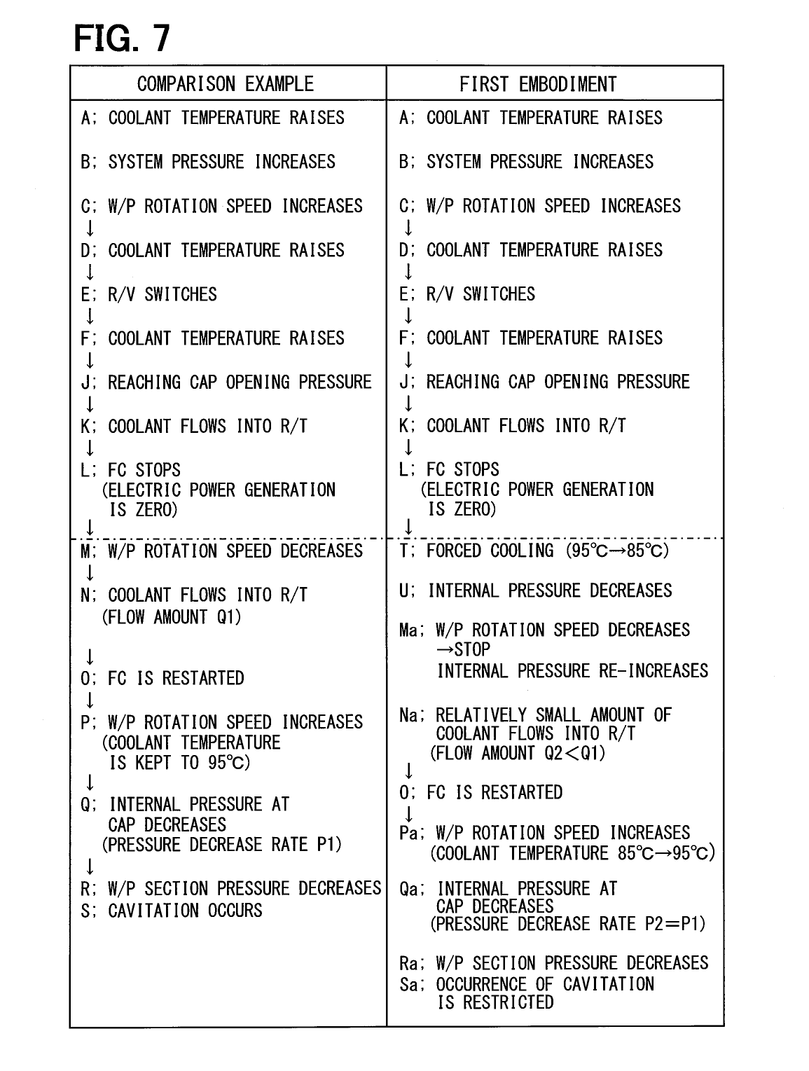

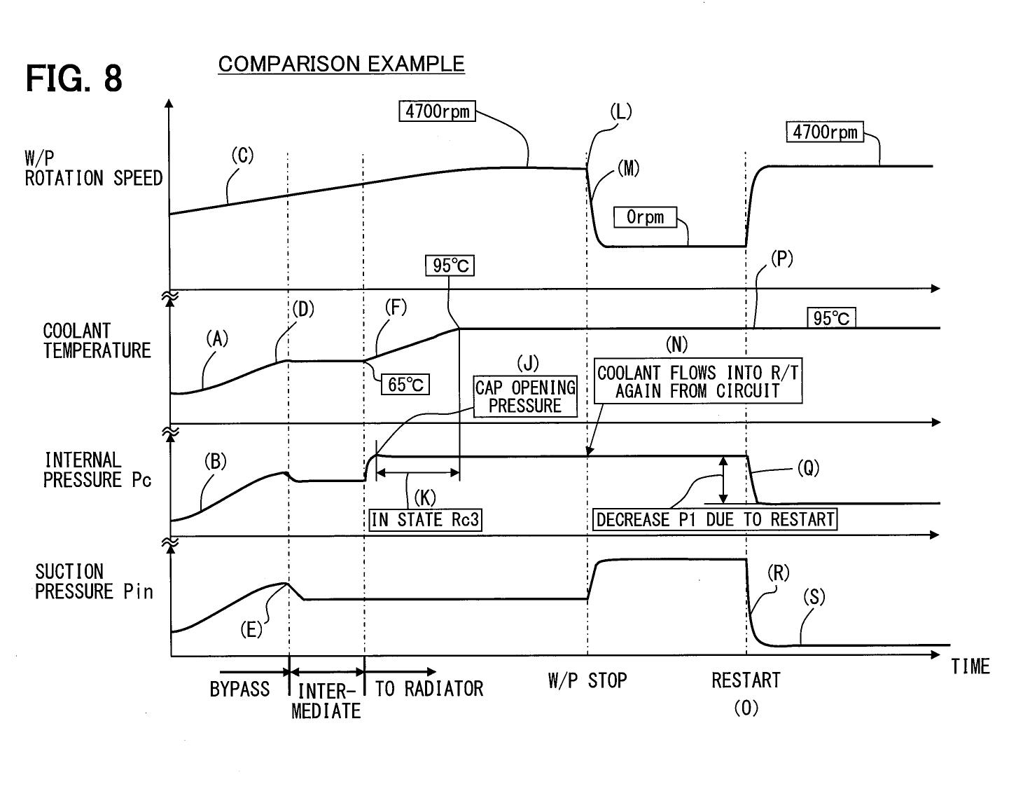

In FIG. 7, first, a control of a comparison example without using the coolant-pump-operation continuation part will be described referring to a left side of FIG. 7. At the same time, a performance mapping in FIG. 8 is described with the same reference numbers (A)-(L) and the like corresponding to FIG. 7. In FIG. 8, the vertical axes are a scale of the rotation speed (i.e., the W/P rotation speed) of the coolant pump 1, a scale of the coolant temperature in the coolant circuit 8, a scale of the internal pressure Pc, and a scale of the suction-side pressure Pin. The horizontal axis is a time scale.

When the coolant temperature increases (A), an internal pressure in the coolant circuit 8, in other words, a system pressure (i.e., the internal pressure Pc), increases (B). Then, a coolant amount is required depending on a heat amount that is generated due to the electric power generation generated by the FC stack in the fuel cell (2) such that a temperature difference between at an inlet of the fuel cell (2) and at an outlet of the fuel cell (2) is kept being smaller than a predetermined value (e.g., 7-10° C.), and the rotation speed of the coolant pump 1 increases (C).

When the coolant temperature is kept increasing (D), the rotary valve (R/V) configuring the switching valve 4 sets the passage such that coolant flows toward the radiator 6 while the rotary valve makes coolant to flow to the bypass passage 5 (E). If the coolant temperature still increases (F), the internal pressure Pc at the reserve-tank inlet valve 10 reaches to the cap opening pressure shown in FIG. 4 (J) and comes into a control area of the area RC3.

In the result, coolant flows through the pipe 15 from the coolant circuit 8 to the reserve tank 9 and flows into the reserve tank (R/T) 9 (K). Accordingly, the coolant temperature increases, and the internal pressure Pc becomes stable.

In such a case, when a driver turns off a vehicle operation key (i.e., an ignition key), for example, to take a rest while traveling a mountain trail, a state that the electric power generation becomes zero (L) since the fuel cell as the driving-energy generator and also as the heat source 2 for the fuel-cell vehicle is stopped operating is caused. The above stream of states is the same between the comparison example and the first embodiment.

The state (L) that the fuel cell (2) is stopped operating and that the electric power generation becomes zero is not limited to be caused when the vehicle stops traveling. Another state that the fuel cell (2) is stopped operating and that the electric power generation becomes zero is, for example, (i) a state that the vehicle is traveling at high load and at high speed (e.g., 160 km/h) and (i) a state that an acceleration is off such that the acceleration is relieved from operating to decrease a vehicle traveling speed or that the vehicle travels downhill, after traveling under a condition that the outside temperature is high such as 40° C.

When the fuel cell (2) is stopped operating and when the electric power generation becomes zero, the coolant pump 1 decreases the performance or is stopped (M). Accordingly, the internal pressure Pc at the reserve-tank inlet valve 10 increases due to equalization of pressure. In the result, the control area comes into the area RC3 shown in FIG. 4 again, and coolant flows in the pipe 15 from the coolant circuit 8 to the reserve tank 9. Accordingly, the coolant flows into the reserve tank 9, and the internal pressure Pc becomes stable. An amount of the coolant flowing into the reserve tank 9 will be referred to as a flow amount Q1 (N) hereinafter.

A driver who finished taking the rest under the above states makes the fuel cell (2) to restart, and the electric power generation increases (O). Accordingly, the coolant pump 1 being stopped is restarted to operate, and the rotation speed increases. In this case, the coolant temperature is kept being 95° C. (P). By restarting the coolant pump 1 to operate, a pressure at a side of a suction port of the coolant pump 1 decreases, and the internal pressure Pc also decreases. A pressure decrease rate of the internal pressure Pc at this time will be referred to as a pressure decrease rate P1 (Q). Accordingly, while the suction pressure of the coolant pump 1 decreases (R), the cavitation is occurred around the suction part of the coolant pump 1 (S).

On the other hand, although the most extreme example of a state that a required coolant amount decreases in the first embodiment is a state that the vehicle is stopped traveling, a control that the coolant amount of the coolant pump 1 does not decreases is performed when the coolant temperature is higher than a predetermined value in a case where the required coolant flow amount decreases due to other various requirement. Accordingly, when the electric power generation is practically zero (L), it is determined at step S62 in FIG. 6 if the coolant temperature detected by the temperature sensor is higher than 85° C. or not.

When the coolant temperature detected by the temperature sensor is higher than 85° C., the electric coolant pump 1 is continuously performed (i.e., performs a forced cooling) (T) at step S63. The process proceeds to step S64 and operates the electric fan 11 that blows air to the radiator 6.

When the coolant temperature decreases to be lower than or equal to 85° C. while the electric power generation of the fuel cell (2) is zero, the process proceeds to step S65 as shown in FIG. 6 and allows the electric coolant pump 1 to stop operating. Thus, the coolant pump 1 stops operating as long as another control does not require the coolant pump 1 to operate. Subsequently, the electric fan 11 is stopped rotating at step S66.

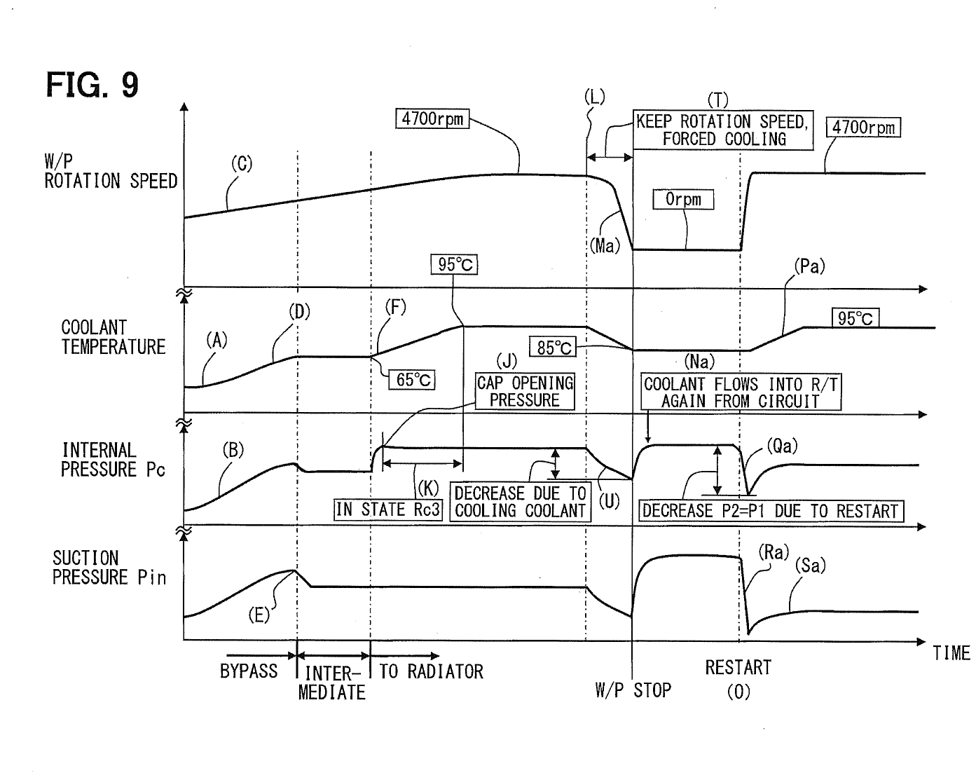

Therefore, as shown in a right side of FIG. 7 and FIG. 9, for example, when the coolant temperature is 95° C., the coolant pump 1 is made continue rotating until the coolant temperature decreases to 85° C. (T). By decreasing the coolant temperature to 85° C., the system pressure in a coolant pipe decreases (i.e., the internal pressure Pc decreases) (U).

While the coolant temperature decreases, the rotation speed of the coolant pump 1 is controlled to decrease (Ma). When the coolant temperature becomes lower than or equal to 85° C., the coolant pump 1 is basically stopped operating as at step S65 in FIG. 6.

By decreasing the rotation speed of the coolant pump 1 or stopping the performance of the coolant pump 1, the pressure Pin at the suction side of the coolant pump 1 and the internal pressure Pc increase again due to the equalization of pressure in the coolant circuit 8. Accordingly, the control area comes into the area RC3 shown in FIG. 4, and coolant flows in the pipe 15 from the coolant circuit 8 to the reserve tank 9 and flows into the reserve tank 9. A flow amount of coolant flowing into the reserve tank 9 at this time will be referred to as the flow amount Q2. The flow amount Q2 is smaller than the flow amount Q1 (Q2<Q1) (Na). The reason is that a re-increase rate of the internal pressure Pc due to a decrease of rotation speed of the coolant pump 1 becomes slower and smaller since the coolant temperature decreases due to the forced cooling (T), and the internal pressure Pc has been decreased.

The driver who finished taking the rest in the above state starts the fuel cell (2) to operate, and the electric power generation increases (O). Accordingly, the coolant pump 1 having being stopped is started, and the rotation speed increases. Further, the coolant temperature increases rapidly from 85° C. to 95° C. (Pa) by restarting the fuel cell (2) to operate. While the rotation speed of the coolant pump 1 increases, the pressure at the suction part of the coolant pump 1 decreases (Ra), and the internal pressure Pc decreases. A pressure decrease rate P2 at this time is equal to the pressure decrease rate P1 of the comparison example (Qa).

Further, as for a coolant weight staying in the coolant circuit 8 (except for in the reserve tank 9), the coolant weight of the first embodiment is heavier than the coolant weight of the comparison example due to the above relationship of Q2<Q1. In other words, a coolant density becomes high due to the forced cooling (T), and the system pressure (i.e., the internal pressure Pc) is balanced in a high pressure state when the coolant temperature increases after the fuel cell (2) is started to operate (Pa). Accordingly, the pressure at the suction part of the coolant pump 1 becomes high, and the occurrence of the cavitation can be restricted (Sa).

Effects according to the first embodiment will be described hereafter. According to the first embodiment, the heat source 2 is the driving-energy generator that may be stopped operating even if the vehicle is traveling, and the coolant-pump-operation continuation part (S63) makes the coolant pump 1 stop rotation after makes the coolant pump 1 continue rotating, during the traveling of the vehicle. Accordingly, in the vehicle in which the driving-energy generator may be stopped operating even if the vehicle is traveling, a traveling performance of the vehicle is not decreased, and a smooth acceleration operation is performed, since a decrease of an energy generating efficiency of the driving-energy generator due to the cavitation caused in the traveling of the vehicle is restricted.

The vehicle is the fuel-cell vehicle in which the heat source 2 is provided with the fuel cell. During the traveling of the vehicle, the coolant pump 1 is made stop rotating after being made continue rotating, only when the fuel cell that configures the heat source 2 is stopped generating electric power.

Accordingly, in the fuel-cell vehicle, the occurrence of the cavitation is restricted in the coolant pump 1 at the time that the fuel cell restarts generating electric power after being stopped generating electric power, even if the fuel-cell vehicle is traveling. Thus, the fuel-cell vehicle or the hybrid vehicle can be driven with a high efficiency.

The heat source 2 is, especially, provided with the fuel cell. Accordingly, heat generated at the fuel cell is not transferred to exhaust gas compared to a case that heat is generated at the engine (i.e., an internal combustion engine). In the result, if an entire amount of heat generated at the fuel cell is smaller than an entire amount of heat generated at the engine, a radiation amount of the heat that is generated at the fuel cell and is transferred through the coolant is larger than a radiation amount of the heat that is generated at the engine and is transferred through the coolant. Therefore, a cooling performance using coolant is very important. Further, a stabilization of the coolant control affects greatly to a performance efficiency of the fuel cell. In such a state, there are great efficiencies with which the occurrence of the cavitation can be restricted in the coolant pump 1, the heat source 2 can be cooled stably, and the heat source 2 can be performed effectively.

The coolant-pump-operation continuation part (S63) makes the coolant pump 1 stop rotating after makes the coolant pump 1 continue rotating until the coolant temperature becomes lower than or equal to the predetermined temperature during the traveling of the vehicle, when the coolant temperature is higher than the predetermined temperature in a case that the heat amount supplied to coolant from the heat source 2 is reduced to a predetermined heat amount.

Accordingly, the coolant-pump-operation continuation part (S63) makes the coolant pump 1 stop rotating after makes the coolant pump 1 continue rotating until the coolant temperature becomes lower than or equal to the predetermined temperature, in a traveling of the vehicle in which the heat amount supplied to the coolant from the driving-energy generator 2 is reduced to the predetermined heat amount. In the result, the pressure at the suction port of the coolant pump 1 is restricted from decreasing when the driving-energy generator 2 is restarted to operate, and when the rotation of the coolant pump 1 is restarted. Accordingly, the occurrence of the cavitation can be restricted in the coolant pump 1. By restricting the occurrence of the cavitation, the heat source 2 can be cooled stably, and the driving-energy generator (i.e., the heat source) 2 can be performed effectively.

The above case that the heat amount supplied to the coolant from the heat source 2 is reduced to the predetermined heat amount is, in other words, a case that a required electric power generation that is generated by the fuel cell that configures the heat source 2 becomes lower than or equal to a predetermined value. Accordingly, when the coolant temperature becomes higher than the predetermined temperature and when the required electric power generation of the fuel cell (2) becomes lower than or equal to the predetermined value, the coolant pump 1 is made stop rotating after being made continue rotating until the coolant temperature becomes lower than or equal to the predetermined temperature even if the vehicle is traveling. In the result, the occurrence of the cavitation can be restricted.

A case that the heat amount supplied from the heat source 2 to the coolant is reduced to a heat amount that is lower than or equal to the predetermined heat amount is, in other words, a case that a required output for the fuel cell that configures the heat source 2 becomes zero or a case that the required output is determined to be zero. Accordingly, when the required output for the fuel cell becomes zero or is determined to be zero regardless if the vehicle is traveling or stopped traveling in a case that the coolant temperature exceeds the predetermined temperature, the coolant pump 1 is made continue rotating until the coolant temperature becomes lower than or equal to the predetermined temperature, and then, the coolant pump 1 is stopped rotating. Accordingly, the occurrence of the cavitation can be restricted.

The case that the heat amount supplied from the heat source 2 to the coolant is reduced to a heat amount that is lower than or equal to the predetermined heat amount is, in other words, a case that the heat source 2 is the fuel cell and that an output current or an output voltage detected by the fuel-cell sensor 3 that detects the output current or the output voltage from the fuel cell becomes zero or is determined to be zero.

Accordingly, when the heat source 2 is the fuel cell and when the output current or the output voltage from the fuel cell detected by the fuel-cell sensor 3 becomes zero or is determined to be zero, the coolant pump 1 is made continue rotating until the coolant temperature becomes lower than or equal to the predetermined temperature, and then, the rotation of the coolant is stopped even while the vehicle is traveling.

The electric fan 11 is used to blow cooling air to the radiator 6 such that the radiator 6 is cooled by the cooling air by operating the electric fan 11 while the coolant-pump-operation continuation part (S63) continues the coolant pump 1 rotating.

Accordingly, a time needed to cool the coolant such that the coolant temperature becomes lower than or equal to the predetermined temperature can be shortened since the radiator 6 is cooled by the cooling air by operating the electric fan 11 while the coolant pump 1 is continued rotating such that the coolant is cooled until the coolant temperature becomes lower than or equal to the predetermined temperature.

While the coolant-pump-operation continuation part (S63) makes the coolant pump 1 continue rotating, the coolant pump 1 discharges coolant with a discharge capacity that is higher than or equal to 50% of the maximum discharge capacity of the coolant pump 1.

Accordingly, the time needed to cool the coolant until the coolant temperature becomes lower than or equal to the predetermined temperature can be shortened since the coolant pump 1 discharges coolant with the discharge capacity that is higher than or equal to 50% of the maximum discharge capacity of the coolant pump 1 while the coolant pump 1 is made continue rotating such that the coolant is cooled until the coolant temperature becomes lower than or equal to the predetermined temperature.

The bypass passage 5 is provided to bypass the radiator 6, and the switching valve 4 switches between the bypass passage 5 and the passage that makes coolant to flow between the heat source 2 and the radiator 6. Accordingly, the switching valve 4 contributes to stabilize the coolant temperature since the switching valve 4 can make the coolant to flow in the bypass passage 5 that bypasses the radiator 6 or in the radiator 6.

The reserve-tank inlet valve 10 is located in the radiator 6 that is disposed to be closer to the suction side of the coolant pump 1 than the switching valve 4. Accordingly, the reserve-tank inlet valve 10 can be provided easily as the radiator cap.

The switching valve 4 makes at least a part of coolant flow toward the radiator 6 while the coolant-pump-operation continuation part (S63) makes the coolant pump 1 continue rotating. Accordingly, the coolant can be cooled promptly by using the radiator 6 even if there is the bypass passage 5.

### Second Embodiment

A second embodiment of the present disclosure will be described hereafter. In the following embodiments, a part that corresponds to a matter described in the first embodiment may be assigned with the same reference number, and redundant explanation for the part may be omitted. A different configuration and a different feature that is different from those of the first embodiment will be described.

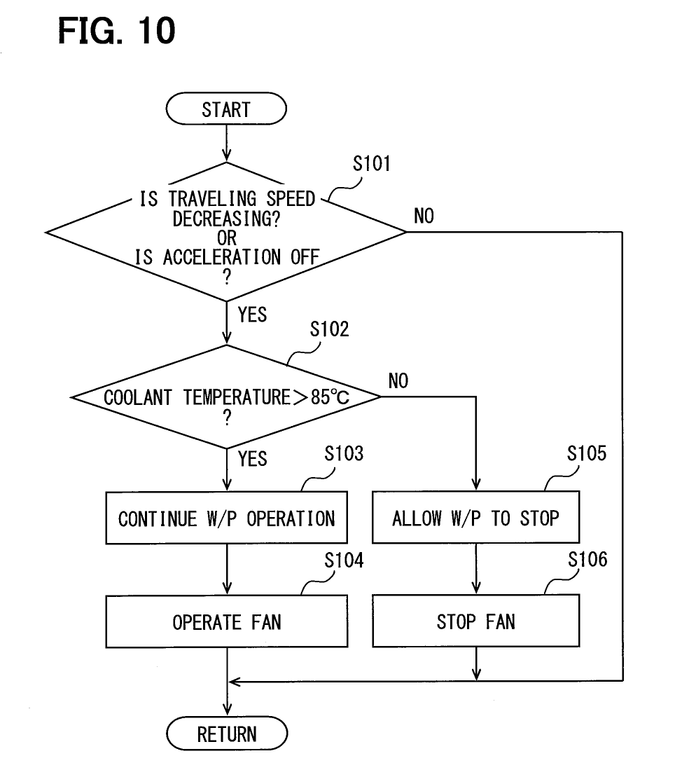

In the first embodiment, when the electric power generation generated by the fuel cell is determined to be practically zero or to be zero, the coolant pump 1 is continued rotating such that the coolant is cooled until the coolant temperature becomes lower than or equal to the predetermined temperature, and then, the coolant pump 1 is stopped rotating. However, according to the second embodiment, it is determined if an operation of the acceleration is off or not, while a traveling speed of the fuel-cell vehicle decreases or while the fuel-cell vehicle is in a regular traveling state, by following step S101 as shown in FIG. 10. When the operation of the acceleration is off, the required electric power generation or the required output for the fuel cell (2) is determined to be zero.

When the traveling speed of the fuel-cell vehicle decreases, or when the operation of the acceleration is off during a normal traveling state, the required electric power generation is determined to be practically zero. When the coolant temperature is determined at step S102 to exceed the predetermined temperature, the coolant pump 1 is continued rotating at step S103. That is, a control operation at step S103 may be performed as an example of the coolant-pump-operation continuation part. Other steps S104, S105, and S106 are the same as corresponding steps in FIG. 6.

Effects of the second embodiment will be described hereafter. The case that the heat amount supplied from the heat source 2 to the coolant is reduced to the predetermined heat amount is, in other words, a case that the acceleration operation for accelerating the fuel-cell vehicle is off, or a case that the required electric power generation of the fuel cell that configures the heat source 2 becomes lower than or equal to the predetermined value.

Accordingly, when the acceleration operation for accelerating the fuel-cell vehicle is off or when the required electric power generation of the fuel cell (2) becomes lower than or equal to the predetermined value, in a case that the coolant temperature exceeds the predetermined temperature, the coolant pump 1 is continued rotating such that the coolant is cooled until the coolant temperature becomes lower than or equal to the predetermined temperature, and then, the coolant pump 1 can be stopped rotating even while the vehicle is traveling.

The case that the heat amount supplied from the heat source 2 to the coolant is decreased to a heat amount that is lower than or equal to the predetermined heat amount is, in other words, the case that the required output for the fuel cell that configures the heat source 2 becomes zero or is determined to be zero.

Accordingly, regardless if the vehicle is traveling or stopped traveling, when the required output for the engine or the fuel cell (2) becomes zero or is determined to be zero in a case that the coolant temperature exceeds the predetermined temperature, the coolant pump 1 is continued rotating such that the coolant is cooled until the coolant temperature becomes lower than or equal to the predetermined temperature, and then, the coolant pump 1 can be stopped rotating even when the vehicle is traveling.

### Third Embodiment

A third embodiment of the present disclosure will be described hereafter. A feature that is different from the above features of the above embodiments will be described. In the first embodiment, the vehicle is the fuel-cell vehicle. According to the third embodiment, the vehicle is a hybrid vehicle that is driven by an engine and a battery. The engine may be used as an example of the heat source 2.

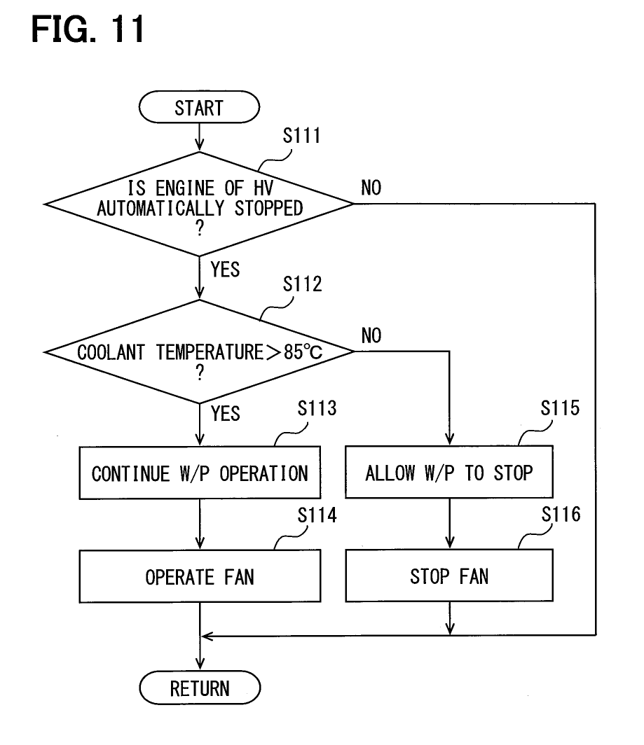

When the engine of the hybrid vehicle is automatically stopped, the coolant pump 1 is made stop rotating after being made continue rotating during the traveling of the vehicle. Accordingly, at step S111 in FIG. 11, it is determined if the engine of the hybrid vehicle is automatically stopped or not.

This matter will be described hereafter. In the hybrid vehicle that is driven by the engine and the battery, the engine may be stopped rotating even when the hybrid vehicle is traveling. It is a case that, for example, the traveling speed decreases, or the operation of the acceleration is off during the normal traveling state. In such a case, by restricting the occurrence of the cavitation in the coolant pump 1 at the time of restarting the engine to rotate, the hybrid vehicle can be driven with a high efficiency.

Therefore, when the engine of the hybrid vehicle is determined to be automatically stopped at step S111 in FIG. 11, a heat amount supplied from the engine that works as the driving-energy generator to coolant is reduced to the predetermined heat amount. In such a case, when the coolant temperature is determined at step S112 to exceed 85° C., the coolant pump 1 is continued rotating at step S113 such that the coolant is cooled until the coolant temperature becomes lower than or equal to the predetermined temperature, and then, the coolant pump 1 is stopped rotating, regardless if the vehicle is traveling or stopped traveling. That is, a control operation at step S113 may be used as an example of the coolant-pump-operation continuation part.

Further, since the coolant pump 1 is electric type, a rotation speed of the engine (2) in an idling state does not affect to the coolant pump 1, in contrast to a coolant pump (i.e., a mechanical pump) that is operated mechanically by the engine (i.e., the heat source 2). Accordingly, when the coolant pump 1 is made continue rotating to perform the forced cooling, the coolant pump 1 is rotated to operate with a discharge capacity that is higher than or equal to 50% of the maximum discharge capacity of the coolant pump 1 such that the coolant temperature decreases, and the discharge capacity decreases while the coolant temperature decreases. Steps S114, S115, and S116 in FIG. 11 are the same as corresponding steps in FIG. 6.

Effects of the third embodiment will be described hereafter. The vehicle is the hybrid vehicle that is driven by the engine configuring the heat source 2 and the battery. During the traveling of the vehicle, the coolant pump 1 is made stop rotating after being made continue rotating when the engine configuring the heat source 2 is automatically stopped during the traveling of the vehicle.

Accordingly, in the hybrid vehicle that is driven by the engine and the battery, the occurrence of the cavitation at the time of the restarting the engine to rotate can be restricted, and the hybrid vehicle can be driven with the high efficiency, in the case that the engine automatically stops even while the hybrid vehicle is traveling.

The coolant-pump-operation continuation part (S113) makes the coolant pump 1 stop rotating during the traveling of the vehicle after makes the coolant pump 1 continue rotating until the coolant temperature becomes lower than or equal to the predetermined temperature, when the heat amount supplied from the engine that works as the heat source 2 of the hybrid vehicle to coolant is reduced to the predetermined heat amount in the case that the coolant temperature exceeds the predetermined temperature.

Thus, the coolant-pump-operation continuation part (S113) makes the coolant pump 1 stop rotating after makes the coolant pump 1 continue rotating until the coolant temperature becomes lower than or equal to the predetermined temperature, when the heat amount supplied from the engine of the hybrid vehicle to the coolant is reduced to the predetermined heat amount during the traveling of the vehicle. Accordingly, the pressure at the suction port of the coolant pump 1 at the time of restarting the engine and the coolant pump 1 to rotate after the engine stops automatically can be restricted from decreasing, and the occurrence of the cavitation in the coolant pump 1 can be restricted. By restricting the occurrence of the cavitation, the engine can be cooled stably, and the engine can perform with the high efficiency.

The case that the heat amount supplied from the heat source 2 to coolant is reduced to lower than or equal to the predetermined heat amount is, in other words, the case that the required output for the engine that configures the heat source 2 becomes zero or is determined to be zero. Accordingly, when the required output for the engine becomes zero or determined to be zero regardless if the vehicle is traveling or stopped traveling in the case that the coolant temperature exceeds the predetermined temperature, the coolant pump 1 is made stop rotating after being made continue rotating until the coolant temperature becomes lower than or equal to the predetermined temperature while the hybrid vehicle is traveling.

The present disclosure is not limited to the above embodiments and can be modified or broaden as follows. For example, although the coolant pump 1 is made continue rotating until the coolant temperature becomes lower than or equal to 85° C. according to the first embodiment, the coolant pump 1 may be made continue rotating until the coolant temperature becomes 85±5° C. (i.e., 80° C.-90° C.). That is, a device that makes the coolant pump 1 stop rotating may make the coolant pump 1 decrease the rotating speed of the coolant pump 1 after makes the coolant pump 1 continue rotating until the coolant temperature becomes lower than or equal to 85 5° C.

Accordingly, since the coolant pump 1 is made decrease the rotation speed after being made continue rotating until the coolant temperature becomes lower than or equal to 85±5° C., the internal pressure Pc of the coolant can be decreases, and an amount of coolant flowing into the reserve tank 9 can be reduced. In the result, the occurrence of the cavitation can be restricted.

1. A heat-source cooling device comprising:
an electric coolant pump;
a heat source that is cooled by coolant discharged by the coolant pump and is used as a driving-energy generator generating energy for traveling of a vehicle;
a radiator in which coolant that is heated at the heat source radiates heat;
a coolant circuit through which the coolant pump, the heat source, and the radiator are connected annularly;
a reserve tank taking the coolant thereinto from the coolant circuit or releasing the coolant to the coolant circuit; and
a reserve-tank inlet valve controlling an inflow of the coolant into the reserve tank and an outflow of the coolant from the reserve tank, wherein
the reserve-tank inlet valve is located between a suction side of the coolant pump and a position in the coolant circuit at which a pressure of the coolant is an intermediate value between a discharge pressure of the coolant pump and a suction pressure of the coolant pump during an operation of the coolant pump, the heat-source cooling device further comprising
a coolant-pump-operation continuation part making the coolant pump continue operating until a temperature of the coolant reduces to be lower than or equal to a predetermined temperature, when the heat source is stopped or is determined to be stopped, and when the coolant temperature exceeds the predetermined temperature.

2. The heat-source cooling device according to claim 1, wherein
the operation of the heat source is capable of being stopped even during a traveling of the vehicle.

3. The heat-source cooling device according to claim 1, wherein
the vehicle is a fuel-cell vehicle in which the heat source is a fuel cell, or a hybrid vehicle in which the heat source is an engine and a battery, and
the coolant-pump-operation continuation part makes the coolant pump continue operating when the fuel cell is stopped generating an electric power during the traveling of the vehicle or when the engine stops automatically during the traveling of the vehicle.

4. The heat-source cooling device according to claim 3, wherein
the heat source is the fuel cell.

5. The heat-source cooling device according to claim 1, wherein
the coolant-pump-operation continuation part determines that the operation of the heat source is stopped when a heat amount supplied from the heat source to the coolant reduces to a predetermined heat amount or when the heat amount is determined to reduce to the predetermined heat amount, and
the coolant-pump-operation continuation part makes the coolant pump continue operating such that the coolant is cooled until the coolant temperature becomes lower than or equal to the predetermined temperature, when the heat source is determined to be stopped during the traveling of the vehicle.

6. The heat-source cooling device according to claim 5, wherein
the heat amount supplied from the heat source to the coolant is determined to reduce to the predetermined heat amount when an acceleration operation for accelerating the fuel-cell vehicle is off or when a required electric power generation of the fuel cell that configures the heat source becomes lower than or equal to a predetermined value.

7. The heat-source cooling device according to claim 5, wherein
the heat amount supplied from the heat source to the coolant is determined to reduce to the predetermined heat amount when a required output from the fuel cell or for the engine that configures the heat source becomes zero or is determined to be zero.

8. The heat-source cooling device according to claim 5, further comprising
a fuel-cell sensor that detects an output current or an output voltage that is output from the fuel cell that configures the heat source, wherein
the heat amount supplied from the heat source to the coolant becomes lower than or equal to the predetermined heat amount when the output current or the output voltage detected by the fuel-cell sensor becomes zero or is determined to be zero.

9. The heat-source cooling device according to claim 1, wherein
the coolant-pump-operation continuation part makes the coolant pump stop operating after makes the coolant pump continue operating until the coolant temperature becomes lower than or equal to 85±5° C.

10. The heat-source cooling device according to claim 1, further comprising
an electric fan blowing a cooling air to the radiator, wherein
the electric fan is operated to cool the radiator by the cooling air while the coolant-pump-operation continuation part makes the coolant pump continue operating.

11. The heat-source cooling device according to claim 1, wherein
the coolant pump is capable of discharging the coolant with a discharge capacity that is higher than or equal to 50% of a maximum discharge capacity of the coolant pump while the coolant-pump-operation continuation part makes the coolant pump continue operating.

12. The heat-source cooling device according to claim 1, further comprising:
a bypass passage bypassing the radiator; and
a switching valve switching between the bypass passage and a flow passage that is connected to the radiator.

13. The heat-source cooling device according to claim 12, wherein
the reserve-tank inlet valve is located in the radiator that is disposed to be closer to a suction side of the coolant pump than the switching valve.

14. The heat-source cooling device according to claim 12, wherein
the switching valve makes at least a part of the coolant flow toward the radiator while the coolant-pump-operation continuation part makes the coolant pump continue operating.
